(19) United States
(12) Patent Application Publication
(10) Pub. No.: US 2010/0082608 A1
(43) Pub. Date: Apr. 1, 2010

(54) SYSTEM, METHOD, OR APPARATUS RELATING TO DETERMINING SEARCH RESULTS BASED AT LEAST IN PART ON ONE OR MORE CONTEXT FEATURES

(75) Inventors: Mauricio Mediano, Cupertino, CA (US); Jason Zien, Mountain View, CA (US); Zengyan Zhang, San Jose, CA (US); Jinhui Liu, Sunnyvale, CA (US); Song Lin, Sunnyvale, CA (US)

Correspondence Address: BERKELEY LAW & TECHNOLOGY GROUP LLP, 17933 NW EVERGREEN PARKWAY, SUITE 250, BEAVERTON, OR, 97006, US

(73) Assignee: YAHOO! INC., Sunnyvale, CA (US)

(21) Appl. No.: 12/242,273

(22) Filed: Sep. 30, 2008

(51) Int. Cl. G06F 7/06; G06F 17/30

(52) U.S. Cl. 707/723; 707/E17.109

(57) ABSTRACT

Embodiments of methods, apparatuses, devices and systems associated with determining search results are disclosed.

### FIELD

Embodiments relate to the field of determining search results, and more specifically to determining search results based at least in part on one or more context features.

### BACKGROUND

Various website operators or content providers provide content on one or more users accessing one or more websites. Under some circumstances it may be desirable for a web site operator to position additional information, such as one or more advertisements, on a web page display to a user. However, under some circumstances particular additional information may be less effective if displayed with particular provided content than that same additional information would be if displayed with other content. Under some circumstances, it may be desirable to determine which additional content may be effective if displayed to a user. Accordingly, systems, methods, or processes associated with determining which additional content to display to a user may be desirable.

### BRIEF DESCRIPTION OF DRAWINGS

Subject matter is particularly pointed out and distinctly claimed in the concluding portion of the specification. Claimed subject matter, however, both as to organization and method of operation, together with objects, features, and advantages thereof, may best be understood by reference of the following detailed description when read with the accompanying drawings in which:

FIG. 1 is a flow-chart diagram of a representation of a method or process in accordance with an embodiment;

FIG. 2 is a schematic diagram of user interface in accordance with an embodiment; and

FIG. 3 is a schematic diagram of a system in accordance with an embodiment.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, procedures, components or circuits that would be known by one of ordinary skill have not been described in detail so as not to obscure claimed subject matter.

Reference throughout this specification to “one embodiment” or “an embodiment” means that a particular feature, structure, or characteristic described in connection with the embodiment is included in at least one embodiment of claimed subject matter. Thus, the appearances of the phrase “in one embodiment” or “an embodiment” in various places throughout this specification are not necessarily all referring to the same embodiment. Furthermore, the particular features, structures, or characteristics may be combined in one or more embodiments.

The World Wide Web includes vast amounts of information or content that may be displayed to a user. For example, a user may utilize an application program, such as a web browser, to display one or more web pages provided by one or more content providers or web site operators. Under some circumstances, a web site operator or content provider may desire to display one or more additional links, such as links to other content, one or more advertisements, or information relating to one or more sponsors along with content on a web page. For example, a web site operator may display advertisements associated with one or more sponsors, such as banner advertisements, pop-up advertisements, or the like along with content requested by a user. Under some circumstances, it may be desirable to determine which advertisement to display with particular content based at least in part on one or more aspects of such content. For example, an advertisement for an auto dealership may, under some circumstances, be more effective if displayed along with an article relating to an auto show than that same advertisement would be if displayed along with an article relating to a movie review.

In an embodiment, aspects of content may include both relatively static aspects, such as static context features, and relatively dynamic aspects, such as dynamic context features, for example. As used herein, a “static context feature” may refer to an aspect of a web page that may change over a somewhat larger time scale. For example, a news article may be associated with one or more relatively static aspects, such as those described above. In an embodiment, static context features may include aspects related to particular content, such as words, categories, phrases, topics, subject matter, or the like. For example, for an article relating to a particular sports team, static context features may include the type of sport, the name of the team, the subject of the article, or the like. As used herein, a “dynamic context feature” may refer to an aspect of a web page that may be relatively dynamic and may change on a some what smaller time scale. For example, a dynamic context feature may include information relating to one or more distinct users. In an embodiment, dynamic context features may include information relating to a particular user, such as location data associated with the user, demographic information associated with a user, such as age, gender, etc., purchase history data, search history data, browsing history data, personal identification data, behavioral analysis data, or the like, Furthermore, it may also be desirable to determine which additional information to display based at least in part on one or more of the above dynamic context features, such as information relating to a particular user. It should, however, be noted that these are merely examples relating to determining additional information to display and claimed subject matter is not limited in this regard.

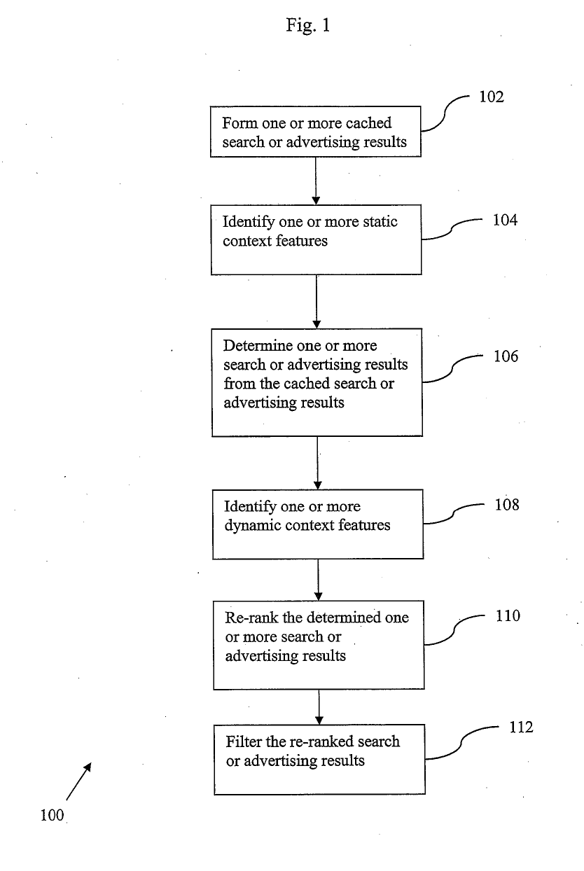

FIG. 1 is a flow-chart diagram of a representation of a method or process in accordance with an embodiment 100. With regard to embodiment 100, a system or process may form one or more cached search results. For example, a system or process may search for one or more additional items, such as one or more links, search results, data, advertisement results, or the like, and store one or more of those search results in a memory cache. In an embodiment, such cached search results may correspond to one or more search results having one or more desirable characteristics. For example, cached search results may comprise one or more advertisements having desirable characteristics relative to one or more static context features of one or more web pages. For example, if one or more web pages are accessed one or more times, it may be desirable to cache search results corresponding to those web pages. Under some circumstances, having one or more cached search results may improve performance of a system or process during operation.

With regard to box 104, a system or process, at least in part in response to a user request to access a particular web page, may identify one or more static context features associated with that particular web page. For example, in an embodiment static context features may comprise words, phrases, concepts, categories, geographic information, topics, or the like, associated with a particular web page. For example, for an article or web page about baseball, a category associated with that article may be sports or baseball, while a topic may be the particular team, or a particular time of a baseball season, such as pre-season, interleague play, or the playoffs, etc. In an embodiment, a system or process may extract one or more static context features from a particular piece of content. For example, a system or process may search for particular words in a particular piece of content. Furthermore, under some circumstances, such as for pages having a threshold number of views in a period of time, a system or process may store extracted static context features associated with such pages for futures use. It should, however, be noted that these are merely illustrative examples relating to static context features and that claimed subject matter is not limited in this regard.

With regard to box 106, a system or process may determine one or more search or advertising results from the one or more cached results based on one or more aspects of the particular web page. For example, a system or process may determine search or advertising results from the cached results based at least in part on one or more identified or extracted static context features associated with a particular web page that has been requested by a user. In an embodiment, static context features associated with the article may be used at least in part to determine one or more search or advertising results from one or more cached search or advertising results. For example, a certain quantity of web pages may have associated cached search results. By way of example, if a particular web page has been viewed a threshold number of times during a period of time, such as 10's of thousands to millions of page views within a time period, such as a number of minutes, hours, or days, it may be advantageous to store search results associated with such web pages in a memory cache. For example, under some circumstances it may be desirable to store search results in a cache for a quantity of frequently viewed pages, such as a top n frequently viewed pages based on a number of page views within a previous day. In at least one embodiment, cached search results may be recalculated for a top n number of pages on a hourly, daily, or weekly basis, though, of course, claimed subject matter is not limited in this regard. In an embodiment, if an appropriate web page has been requested by a user, a system or process may search the one or more cached search results for additional information, such as advertisements, that may be desirable to display along with the requested web page. In this embodiment, the system or process may search the cached one or more search results based at least in part on the extracted or identified static context features associated with a requested web page. Of course, it should be noted that this is merely an example relating to search results and that claimed subject matter is not limited in this regard.

With regard to box 108, a system or process may identify one or more dynamic context features associated with a particular requested web page. In an embodiment, a system or process may identify various information associated with a particular user that has requested a particular web page. For example, a system or process may analyze information relating to a particular user, such as information obtained from a login process, a cookie or other object stored on a computing platform associated with a user, or an internet protocol address associated with a user, at least in part to determine one or more dynamic context features. In an embodiment, a system or process may analyze on one or more quantitative or qualitative aspects of a user's behaviors. In one particular embodiment, the system or process may analyze user behavior, such as intensity or frequency of on-line activity or searches and determine to identify one or more dynamic context features. For example, if a user has recently been shopping for a particular product on-line, a system or process may determine that the user may be interested in sale advertisements for similar products from local or on-line retailers. However, it should be noted that these are merely examples relating to dynamic context features and that claimed subject matter is not limited in this regard.

With regard to box 110, a system or process may re-rank the determined one or more search results based at least in part on the determined one or more dynamic context features. For example, a system or process may initially rank the determined one or more search results based at least in part on the identified one or more static context features. In this example, the determined one or more search results may be re-ranked based at least in part on the identified one or more dynamic context features. For example, search results corresponding to the identified one or more dynamic context features may be ranked higher than search results that have a lesser relation to the one or more dynamic context features. For example, if a user has accessed a web site to view an article relating to a baseball game between a team from Oakland and a team from Minnesota, a system or process may utilize one or more dynamic context features at least in part to determine one or more additional links or advertisements to show to the user, In this example, if it is determined that the particular user is likely an Oakland fan, based at least in part on behavioral analysis or other dynamic context features, a system or process may determine that additional links, or advertisements, relating to the Oakland team's merchandise may be advantageous or desirable. Accordingly, a system or process may re-rank the determined one or more search results so that search result relating to the Oakland team are ranked more highly than other search results, for example. In an embodiment, search results may be re-ranked based at least in part on one or more dynamic context features. For example, a rank of a search result may be raised or lowered based at least in part on one or more correlations between such search results and such dynamic context features. For further example, a web page may have one or more of the following static context features: “personal finance;” “investing;” “retirement;” and “financial advisor.” In this example, a web page may further have the following dynamic context features associated with a user: a location of San Francisco; and age greater than 65. In this example one or more search results may be determined from cached search results based at least in part on the static context features. In this example, the search results could then be re-ranked based at least in part on the dynamic context features. For example, if the initial search yielded 1000 results, those results could then be re-ranked based on the dynamic context features. For example if one or more of the results targeted people over the age of 65 or people in San Francisco, then those results may be placed much higher by the re-ranking. In an embodiment, there may be some circumstances in which dynamic context features, static context features, or combinations thereof, may be somewhat highly selective or restrictive (eg. a query based on such features may constrain search results to a relatively small subset, for instance, people who live in Sunnyvale, Calif.). Under such circumstances, it may be desirable to execute a query based at least in part on the dynamic and static context features without using any cached search results. In such circumstances executing a query without using the cached search results may produce more desirable search results than filtering and re-ranking cached search results. However, it should be noted, that this is merely an illustrative example relating to ranking search results and that claimed subject matter is not limited in this regard.

In an embodiment, such re-ranking may comprise assigning one or more values, such as weights, for example, to one or more search results based on one or more correlations with the dynamic context features. For example, a search result having a positive correlation to one or more dynamic context features may be assigned a weight so that such a search result may be placed near a top of the search results. On the other hand, a search results having a less positive correlation to one or more dynamic context features may be assigned a weight so that such a search results may be placed near a bottom of the search results. In this example, the search results may be re-ranked based at least in part on one or more assigned values or weights as discussed above. In addition, it should be noted that other processes or systems for re-ranking of filtering may be employed. For example, a system or process may employ a decision tree process to re-rank or filter results. For further example, a system or process may employ a machine learning process or method for re-ranking or filtering search results. [However, it should be noted, that this is merely an illustrative example relating to ranking search results and that claimed subject matter is not limited in this regard.

With regard to box 112, a system or process may filter the re-ranked one or more search results based at least in part on the identified one or more dynamic context features. In an embodiment, the re-ranked search results may be filtered at least in part so that search results that are unlikely to be desirable are less likely to be shown to a user. For example, if one or more dynamic context features indicate that a particular user is unlikely to respond to advertisements for particular products or is unlikely to respond to other additional information, then those search results may be removed from the ranked search results so that those results that are unlikely to be desirable are less likely to be shown to a user. It should however, be noted that these are merely illustrative examples relating to filtering and that claimed subject matter is not limited in this regard. For example, under some circumstances, advertisers or web-site operators may want to filter out results based on one or more targeting criteria. For example an advertiser may want to be filtered out based on one or more static feature of a web page, such as a particular category associated with a web page. Likewise, a web page operator may want to filter out one or more advertisements based on an aspect of those advertisements, such as a category or goods or services associated with an advertisement. Likewise, an advertiser or web page may want advertisements filtered out based on one or more dynamic context features, such as a geographic location associated with a user or particular time of day. For example, an advertiser may only want their advertisement to be displayed to users in a particular geographic location or during a particular time of day. In this example, the dynamic context features may be used to filter out that advertiser's advertisements from results displayed to a user.

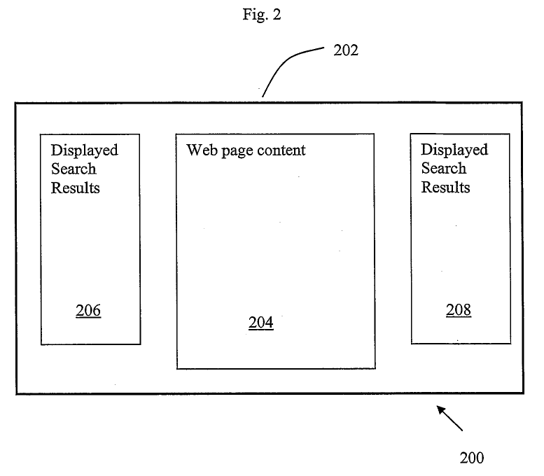

FIG. 2 is a schematic diagram of a user interface in accordance with an embodiment 200. In an embodiment, a user interface 202 may comprise a web page or other content displayed on a display device associated with a computing platform (not shown). For example, user interface 202 may display web page content 204. As discussed above web page content 204 may be any of a wide variety of content. In addition, web page content 204 may correspond to one or more static context features, such as words, phrases, categories, topics, or the like. User interface 202 may also display one or more search results, such as search results 204 and 206, for example. As discussed above, search results 204 and 206 may comprise a variety of additional information, such as links to one or more externals sources of information, advertisements, or the like. In an embodiment, a system or process may identify one or more static context features associated with web page content 204. In an embodiment, a system of process may determine one or more search results based at least in part on one or more static context features associated with web page content 204. For example, a system or process may determine one or more search results from one or more cached search results, such as for a web page having a threshold number of page views in a period of time. Furthermore, a system or process may identify one or more dynamic context features based at least in part on one or more pieces of user information as described above. For example, a system or process may have access to one or more pieces of user information, such as through a login process, cookie, or the like. In an embodiment, the system or process may re-rank the determined search results based at least in part on the identified one or more dynamic context features. For example, a system or process may place search results corresponding to the one or more dynamic context features in a more prominent position within the search results. In addition, a system or process may filter the re-ranked search results based at least in part on the one or more dynamic context features.

Under some circumstances, a method or process may determine search results from one or more non-cached search results, such as if a combination of dynamic context features and static context features meets a threshold selectivity value, such as if it is unlikely that the one or more cached search results would produce desirable search results. For example, if there are less than approximately 50 or so useful cache results, it may be desirable to determine search results without using the cached search results. For example, if a system or process knows that cached search results include a certain quantity of results and that the dynamic or static context features alone or in combination have a probability of returning less that a threshold number of results that it may be desirable to determine search results without using the cache. For example, assume a cache includes 1000 results. Furthermore, assume a certain probability of finding useful search results based on static and dynamic context features due at least in part to a selectivity value associated with static or dynamic context features, Under these circumstances, an estimated number of useful results is equal to the number of cached results multiplied by the probability of finding useful results. For example, if a dynamic context feature is that a user is a male, then a probability of finding useful search results in the cache may be 50%. Accordingly, under that circumstance it may be desirable to determine one or more search results from the cached search results. For another example, if a dynamic context feature is that a user is a male age 18-25 living in Fresno, Calif., having an interest in sailing, then a probability of finding useful search results in the cache may be much lower, such as 0.2%. Under these circumstances, it may accordingly, be desirable to determine search results without using the cached results. It should, however, be noted that this is merely an illustrative example relating to search results and that claimed subject matter is not limited in this regard.

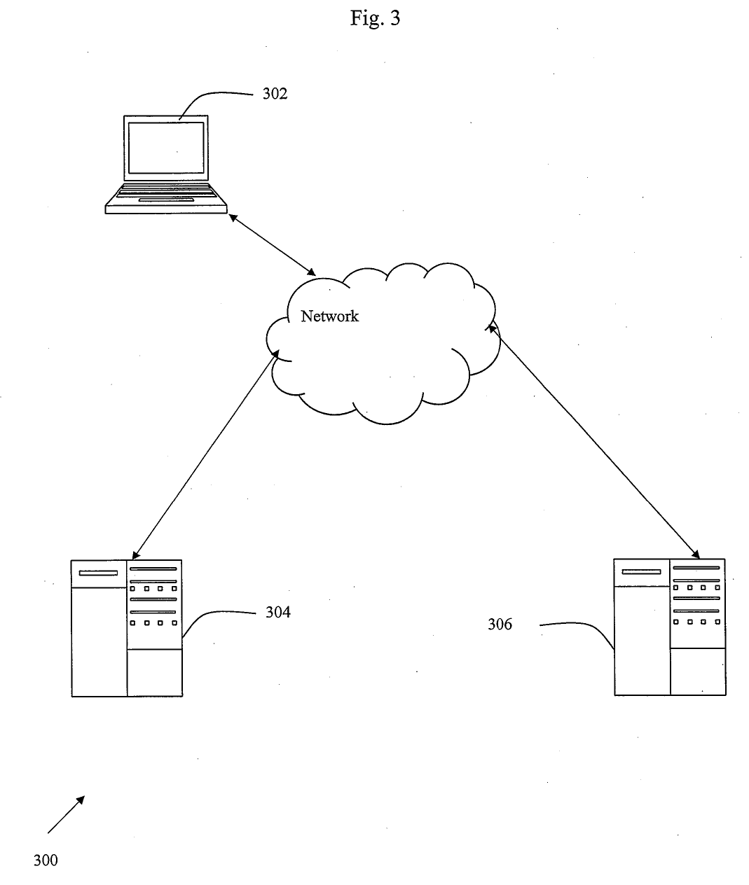

FIG. 3 is a schematic diagram of a system in accordance with an embodiment. 300. With regard to FIG. 3, a user may request a web page, such as by selection of a hyperlink, such as by using an input device associated with computing platform 302 in conjunction with a web browser. Such a user request may be transmitted to another computing platform such as computing platform 304 for processing the request and delivering the requested web page. In addition, computing platform 304 may communicate with computing platform 306 at least in part to determine additional content for transmitting to the user for display, such as one or more advertisements, for example. In this example, computing platform 306 may, determine one or more static context features associated with the requested web page. In addition, computing platform 306 may determine one or more search results based at least in part on one or more cached search results, such as search results stores in a memory device associated with computing platform 306, for example. In an embodiment, computing platform 306 may determine or identify one or more dynamic context features associated with the requested web page as well. As discussed above, dynamic context features may, under some circumstances, be associated with a particular user requesting the web page. For example, computing platforms 306 or 304 may have access to one or more pieces of information associated with the user, such as browsing history, search history, purchase history, location, or the like. In an embodiment, computing platform 306 may re-rank the determined one or more search results based at least in part on the identified one or more dynamic context features, as discussed above. In an embodiment, computing platform 306 may also filter the re-ranked search results based at least in part on the identified dynamic context features, as discussed above. In turn, computing platform 306 may return the search results to computing platform 304 or serve those results directly to computing platform 302 over the network. In this way search results may be more desirable for a particular user based at least in part on those results having been determined based at least in part on one or more static context features and re-ranked and filtered based at least in part on one or more dynamic context features. In another embodiment, computing platform 306 may determine one or more search results, re-rank the determined one or more search results, and filter the re-ranked search results, as described above, from one or more non-cached search results. For example, if a combination of static context features and dynamic context features suggest that the one or more cached search results would not be desirable, then computing platform may search one or more non-cached search results at least in part to provide more desirable search results. It should be noted that these are merely illustrative example relating to a system of providing search results and that claimed subject matter is not limited in this regard.

Unless specifically stated otherwise, as apparent from the following discussion, it is appreciated that throughout this specification discussions utilizing terms such as “processing”, “computing”, “calculating”, “determining”, “ranking”, “re-ranking”, “filtering”, “identifying”, “searching”, “selecting”, “forming”, “initiating”, “querying”, “obtaining”, “representing”, “modifying”, “receiving”, “transmitting”, “storing”, “analyzing”, “creating”, “contracting”, “associating”, “updating”, or the like refer to the actions or processes that may be performed by a computing platform, such as a computer or a similar electronic computing device, that manipulates or transforms data represented as physical, electronic or magnetic quantities or other physical quantities within the computing platform's processors, memories, registers, or other information storage, transmission, reception or display devices. Accordingly, a computing platform refers to a system or a device that includes the ability to process or store data in the form of signals. Thus, a computing platform, in this context, may comprise hardware, software, firmware or any combinations thereof. Further, unless specifically stated otherwise, a process as described herein, with reference to flow diagrams or otherwise, may also be executed or controlled, in whole or in part, by a computing platform.

It should be noted that, although aspects of the above system, method, or process have been described in a particular order, the specific order is merely an example of a process and claimed subject matter is of course not limited to the order described. It should also be noted that the systems, methods, and processes described herein, may be capable of being performed by one or more computing platforms. In addition, the methods or processes described herein may be capable of being stored on a storage medium as one or more machine readable instructions, that if executed may enable a computing platform to perform one or more actions. “Storage medium” as referred to herein relates to media capable of storing information or instructions which may be operated on, or executed by, by one or more machines. For example, a storage medium may comprise one or more storage devices for storing machine-readable instructions or information. Such storage devices may comprise any one of several media types including, for example, magnetic, optical or semiconductor storage media. For further example, one or more computing platforms may be adapted to perform one or more of the processed or methods in accordance with claimed subject matter, such as the methods or processes described herein. However, these are merely examples relating to a storage medium and a computing platform and claimed subject matter is not limited in these respects.

In the preceding description, various aspects of claimed subject matter have been described. For purposes of explanation, specific numbers, systems or configurations were set forth to provide a thorough understanding of claimed subject matter. However, it should be apparent to one skilled in the art having the benefit of this disclosure that claimed subject matter may be practiced without the specific details. In other instances, features that would be understood by one of ordinary skill were omitted or simplified so as not to obscure claimed subject matter. While certain features have been illustrated or described herein, many modifications, substitutions, changes or equivalents will now occur to those skilled in the art. It is, therefore, to be understood that the appended claims are intended to cover all such modifications or changes as fall within the true spirit of claimed subject matter.

1. A method comprising:
determining one or more search results from one or more cached search results based at least in part on one or more static context features; and
re-ranking the determined one or more search results based at least in part on one or more dynamic context features.

2. The method of claim 1, and further comprising filtering the re-ranked search results based at least in part on said one or more dynamic context features.

3. The method of claim 2 and further comprising: identifying said one or more static context features based at least in part on one or more aspects of a web page.

4. The method of claim 3, and further comprising: identifying said one or more dynamic context features based at least in part on one or more user characteristics.

5. The method of claim 3, wherein said one or more aspects of a web page comprise words, phrases, concepts, categories, or location information associated with said web page.

6. The method of claim 4, wherein said one or more user characteristics comprise behavioral information, demographic information, or location information associated with said user.

7. The method of claim 6, wherein said behavioral information comprises search history information, browsing history information, or shopping history information associated with said user.

8. The method of claim 2, and further comprising:
performing a search of one or more non-cached items for one or more search results if an aspect of an at least partial combination of said static context features and said dynamic context features exceeds a threshold selectivity value.

9. The method of claim 2, and further comprising:
forming said one or more cached results based at least in part on a quantity of page views for one or more web pages for a period of time.

10. An article comprising: a storage medium having stored thereon instructions that, if executed by a computing platform, are adapted to enable said computing platform to:
determine one or more search results from one or more cached search results based at least in part on one or more static context features; and
re-rank the determined one or more search results based at least in part on one or more dynamic context features.

11. The article of claim 10, wherein said instructions, if executed by a computing platform, are further adapted to enable said computing platform to filter the re-ranked search results based at least in part on said one or more dynamic context features.

12. The article of claim 11, wherein said instructions, if executed by a computing platform, are further adapted to enable said computing platform to identify said one or more static context features based at least in part on one or more aspects of a web page.

13. The article of claim 11, wherein said instructions, if executed by a computing platform, are further adapted to enable said computing platform to identify said one or more dynamic context features based at least in part on one or more user characteristics.

14. The article of claim 11, wherein said instructions, if executed by a computing platform, are further adapted to enable said computing platform to perform a search of one or more non-cached items for one or more search results if an aspect of an at least partial combination of said static context features and said dynamic context features exceeds a threshold selectivity value.

15. The article of claim 11, wherein said instructions, if executed by a computing platform, are further adapted to enable said computing platform to form said one or more cached results based at least in part on aspect of a history of one or more page views during a period of time.

16. A system comprising:
a computing platform adapted to determine one or more search results from one or more cached search results based at least in part on one or more static context features; and
said computing platform further adapted to re-rank the determined one or more search results based at least in part on one or more dynamic context features.

17. The system of claim 16, wherein said computing platform further adapted to filter the re-ranked search results based at least in part on said one or more dynamic context features.

18. The system of claim 16, wherein said computing platform is further adapted to identify said one or more static context features based at least in part on one or more aspects of a web page.

19. The system of claim 16, wherein said computing platform is further adapted to identify said one or more dynamic context features based at least in part on one or more user characteristics.

20. The system of claim 19, wherein said one or more user characteristics comprise behavioral information, demographic information, or location information associated with said user.
